(19) United States
(12) Patent Application Publication
(10) Pub. No.: US 2006/0208079 A1
(43) Pub. Date: Sep. 21, 2006

(54) RFID testing system

(75) Inventors: Wei Chang, Hsinchu City (TW); Chun-Te Yu, Xiluo Town (TW); Sheng-Pi Wang, Hsinchu City (TW); Shih-Lin Chen, Tainan City (TW); Pei-Chun Chen, Yonghe City (TW); Rita Chang, Puxin Shiang (TW)

Correspondence Address: BRUCE H. TROXELL, SUITE1404, 5205 LEESBURG PIKE, FALLS CHURCH, VA, 22041, US

(73) Assignee: Industrial Technology Research Institute

(21) Appl. No.: 11/132,219

(22) Filed: May 19, 2005

(30) Foreign Application Priority Data
Mar. 21, 2005 (TW) 94108552

(51) Int. Cl. G06K 7/08

(52) U.S. Cl. 235/451

(57) ABSTRACT

The present invention discloses a RFID testing system, comprising an object-under-test having a RFID tag attached thereto, a RFID reader and a tester. Wherein, the tester further comprises: a base; a bar-shaped first rail, mounted on the base in a stationary manner; a bar-shaped second rail, perpendicularly and slidably mounted on the first rail for enabling the second rail to move linearly along the first rail; a bar-shaped third rail, slidably mounted on the second rail and disposed perpendicular to the first and the second rails for enabling the third rail to move linearly along the second rail; and a clamping device, slidably mounted on the third rail for enabling the clamping device to move linearly along the third rail.

### FIELD OF THE INVENTION

The present invention relates to a radio frequency identification device (RFID) testing system, and more particularly, to a system capable of testing the performance of a RFID tag paired with a RFID reader.

### BACKGROUND OF THE INVENTION

All RFID systems consist basically of a reader equipped with an antenna and a RFID tag. The RFID tag is the data carrier part of the RFID system. RFID reader's tasks are to power, read, write and handle the communication to/from the RFID tag. Briefly, the reader's antenna sends out radio signals to communicate with the RFID tag. These signals make a magnetic/electromagnetic field which represents the interrogation zone of the reader. When a RFID tag, which does not usually possess its own voltage supply (battery), enters the interrogation zone of the reader, it will be activated by receiving the required power and time pulse. Then the RFID tag will be ready to communicate and exchange data with the reader through the antenna thereof.

There are numerous RFID readers and RFID tags available on the market that each has different characteristics and properties. The communication between a RFID reader and a RFID tag can be greatly impacted by the environment in which the devices are utilized, since the communication is realized by electromagnetic wave which can be adversely affected by metal, moisture, etc. Thus, the communication range, the readability and the characteristic of a RFID tag as being attached on an object to be interrogated by a RFID reader are dependent on the type of the antenna used by the RFID tag. By virtue of this, it is often desired to achieve an optimal performance of identification and accessing by matching a RFID tag attached to a specific object with a RFID reader selected accordingly while it is implemented in a particular environment and application.

Conventionally, the evaluation of the matching of a RFID tag, an object-under-test and a RFID reader is performed manually that is not only time and labor consuming, but also the evaluation is imprecise by many interferences. Thus, the matching of a RFID tag, an object-under-test and a RFID reader can not be fully evaluated by the conventional manual method.

In a relating prior art revealing in R.O.C. Pat. No. 330297, a non-contact method and apparatus for testing and classifying RFID devices is disclosed, the apparatus comprising a classifier, a reader, at least a legless RFID device, and a personal computer (PC). Wherein, the classifier and the reader are connected to the PC in respective so that the classifier can inform the PC to start a test as soon as the RFID device is positioned at a specific position by the classifier, and thereafter, the reader is enabled to interrogate the RFID device for acquiring a testing result to determine the class of the tested RFID device accordingly. Thus, the classifier informed by the PC with the class of the RFID device can perform a classification operation thereto. However, the apparatus mentioned above can not test the matching of a RFID reader with the RFID tag attached on an object-under-test.

In another relating prior art revealing in U.S. Pat. No. 6,724,308, a RFID tracking method and system is disclosed. It is the object of the RFID tracking method and system mentioned above to utilize an RFID tag assembly and system to track a product or other article during transportation, storage and distribution while reducing the orientation sensitivity of a conventional RFID tag by forming an antenna system comprising a plurality of modular antenna segments. Nevertheless, the method and system of U.S. Pat. No. 9,724,308 also did not address to the problem regarding how to select a RFID reader best-matched to an object-under-test with respect to the RFID tag attached thereto so as to achieve an optimal identification and accessing performance thereby.

Yet, in another relating prior art revealing in U.S. Pat. No. 6,452,496, a radio frequency identification devices and a method of determining a communication range are disclosed. This invention relates to radio frequency identification devices, wireless communication systems, communication methods, methods of forming a radio frequency identification device, methods of testing wireless communication operations, and methods of determining a communication range, however, it also did not address to the problem regarding how to select a RFID reader best-matched to an object-under-test with respect to the RFID tag attached thereto so as to achieve an optimal identification and accessing performance thereby.

In a common distribution center, a RFID reader is fixed to a stationary position and an object-under-test with a RFID tag attached thereto is placed on a plank to be move by a carrier like a forklift, so that the communication range of the RFID reader can be measured and acquired. However, since the carrier used to carry and move the bulky plank with object-under-tests disposed thereon has to be a device with sufficient structure strength and integrity, the carrier is thus usually made of metal so that the measuring accuracy of the communication range is adversely affected because that metal will reflect the electromagnetic wave and thus cause extreme disruption of the RF field.

Therefore, it is in great demand to have a RFID testing system capable of testing the matching of a RFID reader with the RFID tag attached on an object-under-test.

### SUMMARY OF THE INVENTION

It is the primary object of the invention to provide a RFID testing system, capable of using a 3D tester to performing an accessing efficiency test between a RFID tag and a RFID reader and thus enabling a user to select a best-matched pair of RFID reader and RFID tag for a specific object, so that not only the communication range between the selected pair of RFID reader and RFID tag is increased, but also the waste caused by mismatched pair of RFID reader and RFID tag can be prevented.

To achieve the above object, the present invention provides a RFID testing system, comprising an object-under-test having a RFID tag attached thereto, a RFID reader and a tester. Wherein, the tester further comprises:
a base;
a bar-shaped first rail, mounted on the base in a stationary manner;
a bar-shaped second rail, perpendicularly and slidably mounted on the first rail for enabling the second rail to move linearly along the first rail;
a bar-shaped third rail, slidably mounted on the second rail and disposed perpendicular to the first and the second rails for enabling the third rail to move linearly along the second rail; and
a clamping device, slidably mounted on the third rail for enabling the clamping device to move linearly along the third rail.

In a preferred embodiment of the invention, a first driver is arranged at the intersection of the first rail and the second rail for driving the second rail to move linearly along the first rail. In addition, a second driver can be arranged at the intersection of the second rail and the third rail for driving the third rail to move linearly along the second rail. Similarly, there can be a third driver arranged at the intersection of the third rail and the clamping device for driving the clamping device to move linearly along the third rail.

Preferably, the clamping device can be used to fixedly clasp either the object-under-test or the RFID reader.

In a preferred embodiment of the invention, the RFID testing system further comprises: a processing device having a display unit and a memory unit; and a controlling device electrically connected to the processing device and the tester, for controlling the tester to drive the second rail, the third rail and the clamping device to move in a manner relative to each other.

Preferably, the test can be operated manually.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a RFID testing system according to the present invention.

FIG. 2 is a schematic view showing a testing result of the RFID testing system according to the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

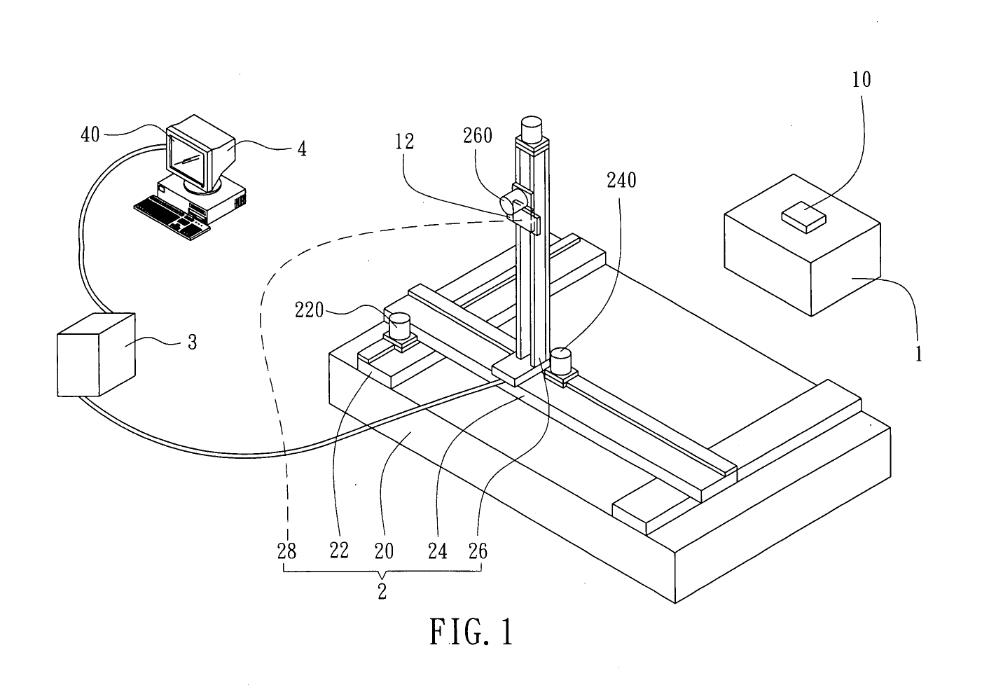

Please refer to FIG. 1, which is a schematic view of a RFID testing system according to the present invention. In FIG. 1, the RFID testing system, comprising an object-under-test 1 having a RFID tag 10 attached thereto, a RFID reader 12 and a tester 2. The tester 2 further comprises a base 20, a first rail 22, a second rail 24, a third rail 26 and a clamping device 28.

The first rail 22 is a bar-shaped rail, which is mounted in the base 20 in a stationary manner. In a preferred embodiment of the invention, the first rail 22 can be integrally formed with the base 20.

The second rail 24 is bar-shaped rail, which is perpendicularly and slidably mounted on the first rail 22 for enabling the second rail 24 to move linearly along the first rail 22. In addition, a first driver 220 is arranged at the intersection of the first rail 22 and the second rail 24 for driving the second rail 24 to move linearly along the first rail 22.

Similarly, the third rail 26 is bar-shaped rail, which is perpendicularly and slidably mounted on the second rail 24 for enabling the third rail 26 to move linearly along the second rail 24. In addition, a second driver 240 is arranged at the intersection of the second rail 24 and the third rail 26 for driving the third rail 26 to move linearly along the second rail 24.

Moreover, the clamping device 28 is slidably mounted on the third rail 28 for enabling the clamping device 28 to move linearly along the third rail 26. In addition, a third driver 260 is arranged at the intersection of the third rail 26 and the clamping device 28 for driving the clamping device 28 to move linearly along the third rail 26.

As seen in FIG. 1, the RFID testing system further comprises a processing device 4, e.g. a personal computer (PC), which has a display unit 40 and a memory unit; and a controlling device 3, e.g. a programmable logic controller (PLC), which is electrically connected to the processing device 4 and the tester 2, for controlling the tester 2 to drive the second rail 24, the third rail 26 and the clamping device 28 to move in a manner relative to each other.

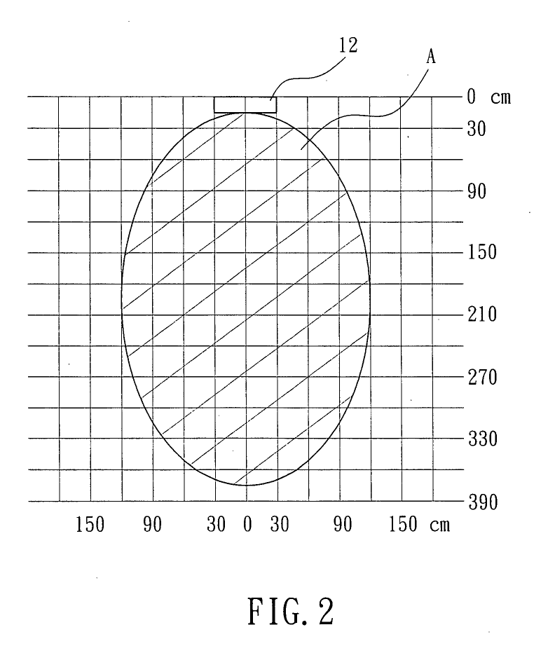

While a testing is being performed by the RFID testing system, the object-under-test 1 with the RFID tag 10 is placed in front of the tester 2 while the RFID reader 12 is fixed on the clamping device 28. Thereafter, the processing device 4 is operated by a user to direct the controlling device 3 for controlling the tester 2 to drive the second rail 24, the third rail 26 and the clamping device 28 to move successively in a manner relative to each other. At the same time, the RFID reader will interrogate the RFIG tag 10 and transmit the result corresponding to the interrogation to the processing device 4, which can be mapped into a diagram as seen in FIG. 2 (the area of FIG. 2 defined by the area A represents the communication of the RFID reader 12).

In another preferred embodiment, contrarily to the above embodiment, the RFID reader 12 is placed in front of the tester 2 while the object-under-test 1 with the RFID tag 10 is fixed on the clamping device 28. Moreover, the tester 2 can be operated manually or automatically.

From the above description, it is noted that the tester 2 can be made of non-metal material since the structure strength thereof only requires the same to sustain the movement of the light-weighted RFID reader 12. Therefore, the RFID testing system of the invention is free from the disruption of RF field caused by metal so that a preferred testing result can be achieve.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A RFID testing system, comprising:
an object-under-test, having a RFID tag attached thereto;
a RFID reader; and
a tester, further comprising:
a base;
a bar-shaped first rail, mounted on the base in a stationary manner;
a bar-shaped second rail, perpendicularly and slidably mounted on the first rail for enabling the second rail to move linearly along the first rail;
a bar-shaped third rail, slidably mounted on the second rail and disposed perpendicular to the first and the second rails for enabling the third rail to move linearly along the second rail; and
a clamping device, slidably mounted on the third rail for enabling the clamping device to move linearly along the third rail.

2. The RFID testing system of claim 1, wherein a first driver is arranged at the intersection of the first rail and the second rail for driving the second rail to move linearly along the first rail.

3. The RFID testing system of claim 1, wherein a second driver is arranged at the intersection of the second rail and the third rail for driving the third rail to move linearly along the second rail

4. The RFID testing system of claim 1, wherein a third driver is arranged at the intersection of the third rail and the clamping device for driving the clamping device to move linearly along the third rail.

5. The RFID testing system of claim 1, wherein the clamping device is capable of fixedly clasp a device selected from the group consisting of the object-under-test and the RFID reader.

6. The RFID testing system of claim 1, further comprising a processing device and a controlling device electrically connected to the processing device and the tester.

7. The RFID testing system of claim 1, wherein the tester is operated manually.

8. The RFID testing system of claim 6, wherein the processing device further comprises a display unit.

9. The RFID testing system of claim 6, wherein the processing device further comprises a memory unit

10. The RFID testing system of claim 6, wherein the controlling device is capable of controlling the tester to drive the second rail, the third rail and the clamping device to move in a manner relative to each other.
